(19) United States
(12) Patent Application Publication
(10) Pub. No.: US 2025/0136254 A1
(43) Pub. Date: May 1, 2025

(54) OFFSHORE FLOATING POWER GENERATION PLATFORM

(71) Applicant: MIGHTY WAVES ENERGY, LLC., Gaithersburg, MD (US)

(72) Inventors: Doug Wolfe, Gaithersburg, MD (US); Mark Hessels, Gaithersburg, MD (US)

(73) Assignee: MIGHTY WAVES ENERGY, LLC., Gaithersburg, MD (US)

(21) Appl. No.: 18/930,064

(22) Filed: Oct. 29, 2024

Related U.S. Application Data
(60) Provisional application No. 63/594,995, filed on Nov. 1, 2023.

(51) Int. Cl. B63B 35/44; B63B 21/50; B63B 39/00; B63B 75/00

(52) U.S. Cl. CPC B63B 35/44; B63B 21/50; B63B 39/00; B63B 75/00; B63B 2035/446

(57) ABSTRACT

A floating power generation platform includes a water plane platform including a plurality of buoyant columns, and at least one central structure extending above the water plane platform and configured to support at least one power generation system. At least one buoyant column of the plurality of buoyant columns is rotatable about a longitudinal axis of the at least one central structure between an unrotated position and a rotated position to move the floating power generation platform between a transportation configuration and a deployed configuration.

### TECHNICAL FIELD

The present disclosure relates generally to offshore power generation systems, and more particularly to an offshore floating power generation platform.

### BACKGROUND

Floating power generation is becoming increasingly critical to the future of power generation, as efforts are being made to isolate renewable energy technologies further away from sensitive environmental ecosystems near shore, such as fisheries, birds, marshes, and human development. For example, platforms supporting wind turbines and other power generation technology will be used to implement such offshore power generation. Estimates are that 80% of the offshore wind market needs to be floating, and there is a significant need for a cost-effective, high-performance design of these platforms that minimizes specialized infrastructure and vessels necessary for deployment.

Current floating platform designs include semi-submersible systems that utilize ballast columns to adjust buoyancy and provide stability, spar buoys with substantial depth for stability, or tension leg platforms that rely on mooring lines to anchor the platform to the sea floor. These systems have distinct disadvantages in different phases of their deployment, operation, and retirement. Additionally, such floating designs have not achieved optimal power performance at an affordable price. Moreover, extreme offshore conditions are not typically accounted for or mitigated in these floating designs, as conventional floating power production designs retain the constraints of land-based systems and involve unnecessary complexity and cost. Moving offshore energy platforms farther from land can be beneficial to increase apparent wind and currents available for capture of renewable energy, and decrease the effects of the offshore platform on sensitive environmental ecosystems near shorelines.

### SUMMARY

An offshore floating power generation platform is therefore described herein that is economical and can improve manufacturing, shipping, and deployment considerations. Specifically, the floating power generation platform described herein is configured to support various energy conversion systems and incorporate rotating, inflatable, and mixed buoyancy portions of the platform to improve shipping, deployment, construction, and reduced weight considerations. The floating power generation platform can deliver various operational benefits of a combination of other floating platform designs, such as semi-submersible, spar buoy, and tension leg platforms in a single structure. Furthermore, the described platform can significantly reduce deployment costs and minimize special purpose and costly deployment vessels. Also, the structures and methods described can be scalable to suit multiple sizes of floating platforms as needed. As a result, performance of the floating power generation platform is increased and overall operating costs are reduced. Additionally, the floating power generation platform facilitates the rapid deployment of renewable energy technology in ocean areas where the depth ranges from a few meters to hundreds of meters.

According to an aspect of this disclosure, a floating power generation platform includes a water plane platform including a plurality of buoyant columns, and at least one central structure extending above the water plane platform and configured to support at least one power generation system. At least one buoyant column of the plurality of buoyant columns is rotatable about a longitudinal axis of the at least one central structure, relative to at least another one buoyant column of the plurality of buoyant columns, between an unrotated position and a rotated position to move the floating power generation platform between a transportation configuration and a deployed configuration.

According to an embodiment of at least one paragraph(s) of this disclosure, the plurality of buoyant columns includes a first group of two or more buoyant columns rigidly connected to each other, and a second group of two or more buoyant columns rigidly connected to each other. At least one of the first group or the second group is rotatable about the longitudinal axis of the at least one central structure between an unrotated position and a rotated position to move the floating power generation platform between a transportation configuration and a deployed configuration.

According to another embodiment of at least one paragraph(s) of this disclosure, the floating power generation platform further includes one or more cross braces configured to connect two or more of the plurality of buoyant columns to each other when the plurality of buoyant columns are in the unrotated position and the floating power generation platform is in the deployed configuration.

According to another embodiment of at least one paragraph(s) of this disclosure, each of the plurality of buoyant columns include a central column center and an outer column portion.

According to another embodiment of at least one paragraph(s) of this disclosure, the central column center is made of a rigid material.

According to another embodiment of at least one paragraph(s) of this disclosure, the outer column portion is configured to selectively adjust a buoyancy of the floating power generation platform.

According to another embodiment of at least one paragraph(s) of this disclosure, the outer column portion is inflatable to selectively adjust the buoyancy of the floating power generation platform.

According to another embodiment of at least one paragraph(s) of this disclosure, the outer column portion is made of a mixed buoyancy material to selectively adjust a buoyancy of the floating power generation platform.

According to another embodiment of at least one paragraph(s) of this disclosure, the plurality of buoyant columns are connected to the at least one central structure with a plurality of struts.

According to another embodiment of at least one paragraph(s) of this disclosure, the at least one central structure includes a tower having a hollow center core, and a deployable rigid spar.

According to another embodiment of at least one paragraph(s) of this disclosure, the deployable rigid spar is movable between a stowed position, in which the deployable rigid spar is stowed within a center core of the tower, and a deployed position, in which the deployable rigid spar is extended below the water plane platform and each of the plurality of buoyant columns.

According to another embodiment of at least one paragraph(s) of this disclosure, the deployable rigid spar has a telescoping configuration for deployment and retraction.

According to another embodiment of at least one paragraph(s) of this disclosure, the floating power generation platform further includes a lock configured to lock the deployable rigid spar in either the deployed and stowed positions.

According to aspect of this disclosure, a method of deploying a floating power generation platform includes the step of assembling the floating power generation platform near a shore, wherein the assembling includes assembling the floating power generation platform to be configured to transition between a transportation configuration and a deployed configuration. The method also includes the steps of transporting the floating power generation platform to an offshore deployment location in the transportation configuration, and transitioning the floating power generation platform from the transportation configuration to the deployed configuration at the offshore deployment location.

According to an embodiment of at least one paragraph(s) of this disclosure, the transitioning includes rotating one or more of a plurality of buoyant columns around a longitudinal axis of the floating power generation platform from an unrotated position to a rotated position.

According to another embodiment of at least one paragraph(s) of this disclosure, the transitioning includes connecting the plurality of buoyant columns to each other in the rotated position.

According to another embodiment of at least one paragraph(s) of this disclosure, the transitioning includes deploying a deployable rigid spar from a stowed position to a deployed position in which the deployable rigid spar extends beneath a water plane platform of the floating power generation platform to a predetermined operational depth.

According to another embodiment of at least one paragraph(s) of this disclosure, the transitioning includes locking the deployable rigid spar in the deployed position.

According to another embodiment of at least one paragraph(s) of this disclosure, the method further includes the step of operating at least one power generation system supported on the floating power generation platform.

According to another embodiment of at least one paragraph(s) of this disclosure, the method also includes the step of disabling the at least one power generation system for a predetermined amount of time.

The following description and the annexed drawings set forth in detail certain illustrative embodiments described in this disclosure. These embodiments are indicative, however, of but a few of the various ways in which the principles of this disclosure may be employed. Other objects, advantages and novel features will become apparent from the following detailed description when considered in conjunction with the drawings.

### BRIEF DESCRIPTION OF DRAWINGS

The annexed drawings show various aspects of the disclosure.

FIG. 1 is a perspective view of an exemplary floating power generation platform in a deployed configuration.

FIG. 2 is a perspective view of the exemplary floating power generation platform in a transportation configuration.

FIG. 3 is a perspective view of a water plane platform of the exemplary floating power generation platform.

FIG. 4 is a side partial cross-sectional view of the water plane platform of the exemplary floating power generation platform with the deployable spar in a stowed position.

FIG. 5 is a side partial cross-sectional view of the water plane platform of the exemplary floating power generation platform with the deployable spar in a deployed position.

FIG. 6 is a schematic view of the water plane platform of the exemplary floating power generation platform in a deployed configuration.

FIG. 7 is a schematic view of the water plane platform of the exemplary floating power generation platform in a transportation configuration.

FIG. 8 is a flowchart of a method of deploying a floating power generation platform.

### DETAILED DESCRIPTION

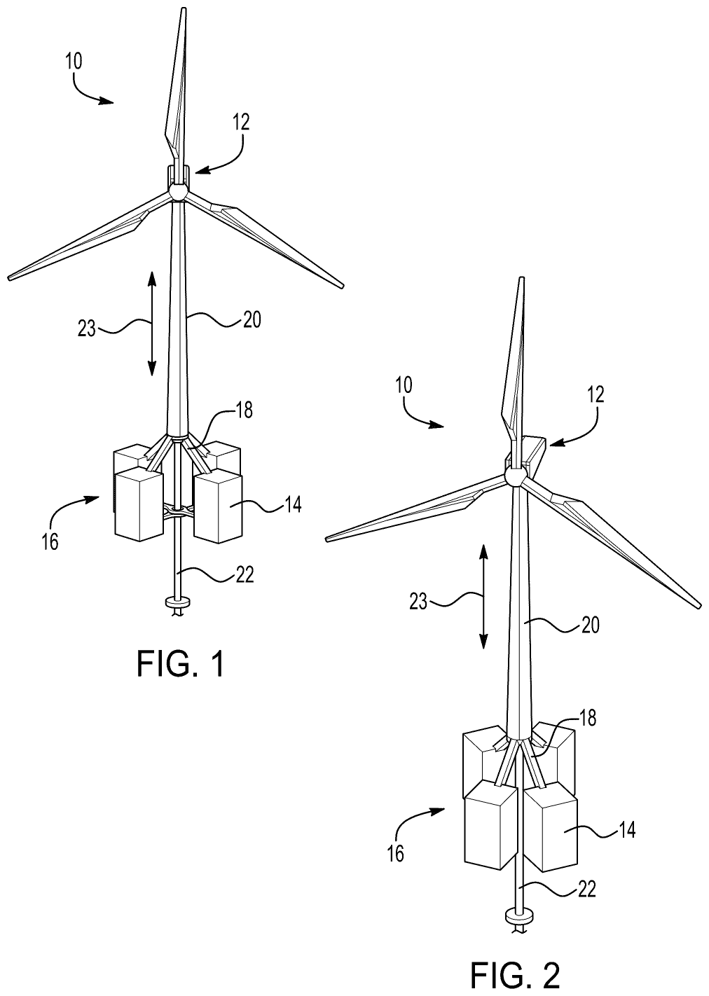

With reference to FIGS. 1 and 2, an exemplary floating power generation platform 10 is depicted. The floating power generation platform 10 is depicted in a deployed configuration in FIG. 1 and in a transport configuration in FIG. 2, the details of which will be described in more detail below. In the transport configuration (FIG. 2), at least one dimension of the floating power generation platform 10 is reduced relative to the deployed configuration (FIG. 1) to reduce cost, effort, and necessary time of transportation of the floating platform 10 to the floating platform's deployment location. The reduction of dimensions can also minimize the cost and need for special purpose deployment vessels, whether they are over land vehicles, port cranes, or boats/ships to tow the floating platform to its deployment location. Additionally, the reduced dimensions can also help the floating platform fit within available ingress and egress constraints available within a given port and navigational system.

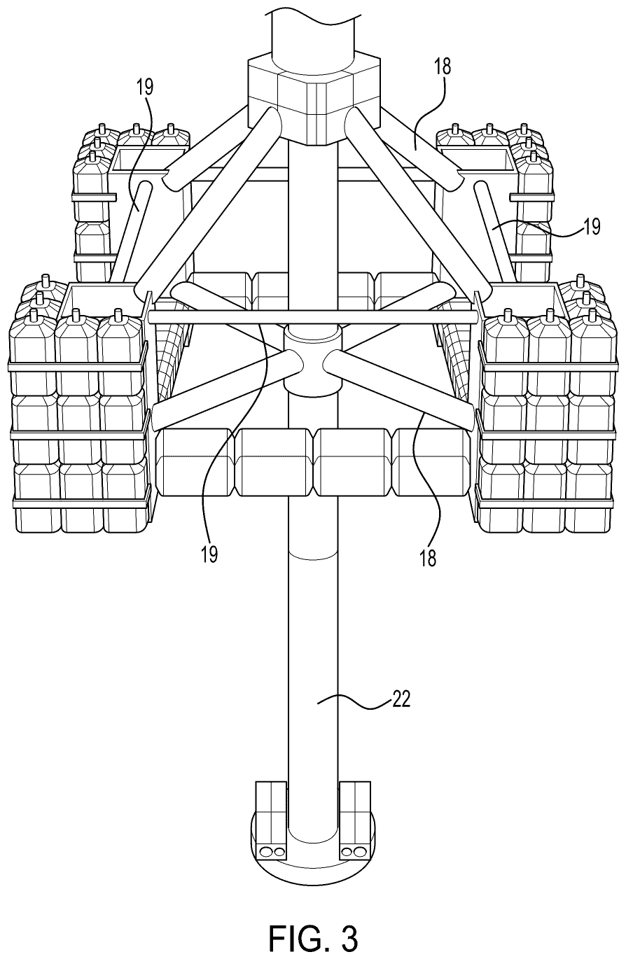

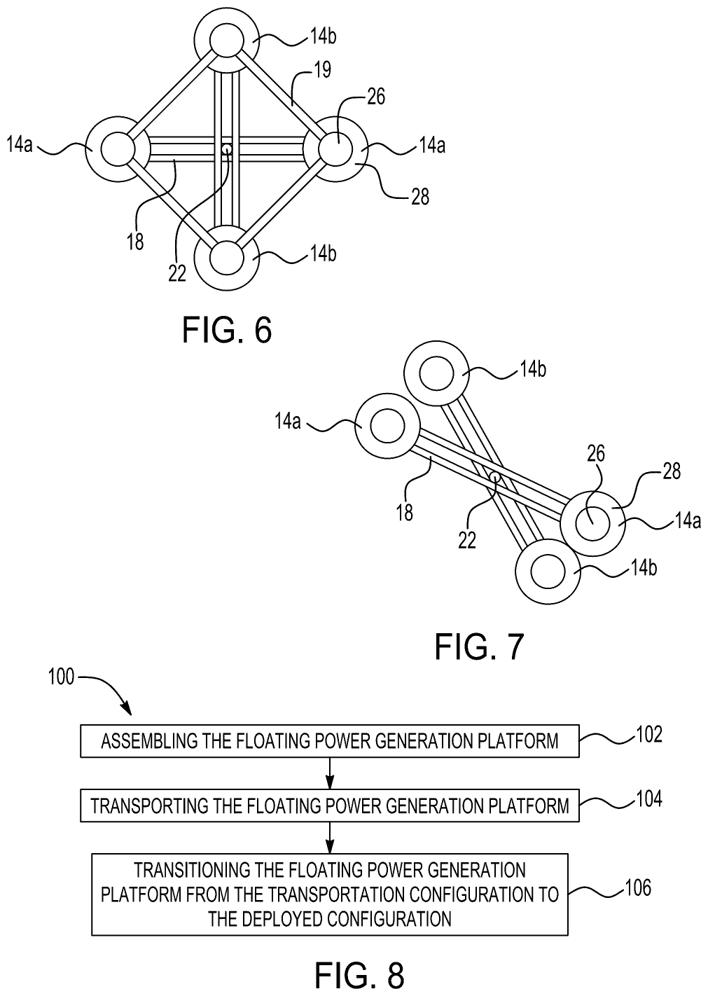

The floating power generation platform 10 is configured to be semi-submersible in a body of water and support one or more power generation systems (e.g., at least one wind turbine 12, at least one wave energy collector, and/or at least one solar energy collector) thereon. The floating power generation platform 10 includes a plurality of buoyant columns 14 that form a water plane platform 16. For example, as depicted in the exemplary embodiments, the water plane platform 16 of the floating power generation platform 10 may have an overall rectangular structure made of four buoyant columns 14. Each of the plurality of buoyant columns 14 are connected to a central structure, such as a tower 20 and/or a spar 22, of the floating power generation platform 10. A plurality of struts 18 or other frame structures may be used to connect the plurality of buoyant columns 14 to the central structure, such that the plurality of buoyant columns 14 and overall floating power generation platform 10 may be balanced. The struts 18 can be made of pipes or other structural material to develop a relatively rigid frame. As depicted in FIGS. 3 and 6, when the platform 16 is in the deployed configuration, the plurality of buoyant columns 14 may be attached to each other with attachment structures such as cross braces 19. The cross braces 19 can include pipes or tension members (e.g., cables) that are selectively attachable to each of the plurality of buoyant columns 14.

It is understood that the water plane platform 16 may have another shaped structure and may have a different number of buoyant columns 14 and struts 18 connecting the buoyant columns 14 to the central structure. In any embodiment, one column 14 can be diametrically opposed to another column 14, or the plurality of columns 14 can be equally spaced about a circumference of the floating platform 10. It is understood that the depicted embodiments are provided as non-limiting examples and that other numbers and arrangements of buoyant columns 14 may be applicable to the water plane platform 16 described herein, such as for example, a water plane platform 16 having two, three, five, or more than six buoyant columns 14.

The central structure of the floating power generation platform 10 may include at least one tower 20 that extends above the water plane platform 16. The tower 20 may be configured to support the at least one power generation system, for example the wind turbine 12, as depicted. The floating power generation platform 10 and at least one tower 20 may be specifically designed to support a variety of power generation systems and wind turbine technologies, depending on which is most desirable for the location and application. For example, as depicted in FIG. 1, the floating power generation platform 10 and at least one tower 20 may be configured with the strength and stability to support a horizontal axis wind turbine 12. Alternatively, the floating power generation platform 10 and at least one tower 20 may be configured with the strength and stability to support a vertical axis wind turbine 12. It is understood that the floating power generation platform 10 and at least one tower 20 may be configured to support any other type of power generation system or wind turbine technology.

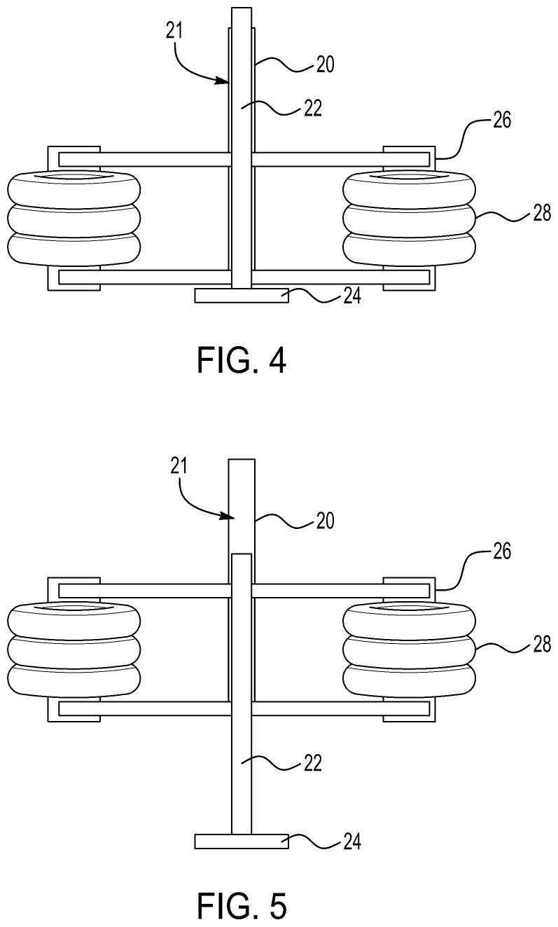

As depicted in more detail in the side views of the floating power generation platform 10 in FIGS. 4 and 5, respectively, the at least one tower 20 may include a hollow center core 21 in which a deployable spar 22 may be stowed. Specifically, when the floating power generation platform 10 is in the transportation configuration (FIG. 2), the deployable spar 22 may be stowed in the at least one tower 20 in a stowed position (FIG. 4). Once the floating power generation platform 10 is brought to an offshore deployment location and the platform 10 is transformed to the deployed configuration (FIG. 1), the deployable spar 22 may be extended below the water plane platform 16 to a deployed position (FIG. 5).

The deployable spar 22 may have several nested structural members that deploy to increase the depth below the platform. In the deployed position, the deployable spar 22 may extend below the water plane platform 16 and each column 14 to a predefined operational depth to create stability, especially in peak operational and storm conditions. The predefined operational depth of the deployable spar 22 may be determined based on a desired operating stability of the particular power generation systems supported on the floating power generation platform 10. For example, the predefined operational depth of the deployable spar 22 may depend on a height of the wind turbine 12 supported on the tower 20. A mass 24 may be attached at the base of the deployable spar 22 that can also act as a heave plate and be shaped to reduce motion and counteract force originating from the energy generators at or above the surface. The tower 20 and the deployable spar 22 may be configured on a single buoyant column 14, such as a center buoyant column 14, or may be configured centrally between each of the plurality of buoyant columns 14, as depicted. The struts 18 may be configured, therefore, to connect each of the plurality of buoyant columns 14 to the tower 20 and deployable spar 22.

The spar 22 can include multiple useful functions including energy storage and pumping water from a lower depth to other locations on the platform for cooling purposes. For example, the deployable spar 22 may be configured to support or house an additional at least one power generation system, storage, or consumption features, the collective mass of which may be used for additional overall platform stabilization. For example, the deployable spar 22 may support or house power generators, such as small modular reactors, water desalination systems, and/or hydrogen generators, and may additionally or alternatively house energy storage, such as one or more batteries, and/or energy consuming systems such as computing servers. Various computing systems housed in the deployable spar 22 may, for example, facilitate the interconnection of the floating power generation platform 10 with other floating power generation platforms in an offshore floating wind farm. The mass of the additional systems provided in or on the deployable spar 22, for example at a bottom thereof or along a length thereof, serves to counterbalance the weight and forces of the wind turbine 12. The deployable spar may also house auxiliary power generation and energy storage units. The shape of the deployable spar 22 may be optimized for housing utility functions and for counteracting the forces at the top of the wind turbine 12. The exact shape and cross-section of the deployable spar 22 may be designed specifically for the operational location and the desired functions of the floating power generation platform 10.

A plurality of flexible lines, such as chains or anchor lines, may secure the deployable spar 22 to each of the plurality of columns 14. A length of each of the flexible lines may be such that each of the flexible lines are under tension when the deployable spar 22 is fully extended. Therefore, as the floating power generation platform 10 undergoes motion, the flexible lines will be in tension on the compensating side of the water plane platform 16 and minimize the relative motion between the deployable spar 22 and the plurality of columns 14. A lock may be provided for rigidly locking the deployable spar 22 in a fully extended position.

Lowering the spar 22 to the fully extended position can lower the center of gravity of the platform 10. In some examples, lowering of the center of gravity can be measured relative to a surface of a body of water, and can mean decreasing a distance between a center of gravity and the surface of the body of water. The lowering of the center of gravity can mean decreasing the distance between a center of gravity and the center of the earth along a direction parallel to the earth's gravitational pull. Lowering the center of gravity can relate to the floating platform 10 alone or a combination of the floating platform 10 and the structures mounted to the floating platform 10 (e.g., the at least one wind turbine 12). In some examples, the center of gravity can be lowered by meters in order to increase the stability and survivability of the floating platform 10. A device configured to selectively raise or lower the center of gravity at the operating location can be included on the floating platform.

The plurality of buoyant columns 14 may be connected to the central structure (e.g., the tower 20 and/or the spar 22) with the struts 18 in a manner that allows for rotational movement of one or more buoyant column 14 of the plurality of buoyant columns 14 about a longitudinal axis 23 of the central structure, relative to one or more other buoyant column 14 of the plurality of buoyant columns 14. Specifically, the plurality of buoyant columns 14 may be connected to the central structure in a manner that allows for both free rotational movement of the plurality of buoyant columns 14 around the longitudinal axis 23 of the central structure, while also enabling a locking feature for preventing such free rotational movement. For example, with further reference to FIGS. 6 and 7, the plurality of buoyant columns 14 can be grouped, such that two or more of the plurality of buoyant columns 14 are in a first group 14a and two or more of the plurality of buoyant columns 14 are in a second group 14b. The columns 14 of the first group are rigidly connected to at least one other column 14 of the first group 14 with one or more strut 18, and the columns 14 of the second group are rigidly connected to at least one other column 14 of the second group 14b with one or more strut 18. The columns 14 may be connected to each other with the struts 18 at one or more elevations of the columns 14. Prior to deployment of the floating platform 10 to its deployment location, at least one group of columns 14a, 14b can rotate relative to another group of columns 14a, 14b to a rotated position (FIG. 7) and be temporarily fixed in the rotated position (FIG. 7) for the duration of transportation and during some portions of deployment. Thus, the floating power generation platform 10 may be transformed to the transportation configuration when the plurality of buoyant columns 14 are rotated to the rotated position (FIGS. 2 and 7). When the floating power generation platform 10 reaches the deployment location, the at least one group of columns 14a, 14b can rotate relative to the other group of columns 14a, 14b back to an unrotated position (FIG. 6) to transition the floating platform 10 from the transportation configuration (FIG. 2) to the deployed configuration (FIG. 1). That is, the floating power generation platform 10 is in the deployed configuration when the plurality of buoyant columns 14 are rotated back to the unrotated position (FIGS. 1 and 6). In the unrotated position (FIG. 6), the columns 14 or groups of columns 14a, 14b can then be attached to one another with the cross braces 19 at one or more elevations of the columns 14. At future points in time, the plurality of buoyant columns 14 may be selectively rotated again to the rotated position to more easily move the floating platform 10 via towing or other means to a ship or port for maintenance or retrofit activities. The floating platform 10 can then be re-deployed following the same process described above. It is understood that other rotation and mounting arrangements may be suitable. For example, single-column groups may be selectively rotated from a first position to a second position to achieve the same or similar results.

When the floating power generation platform 10 is in the deployed configuration (FIGS. 1 and 6) at the deployment location, the operational buoyancy of each column 14 may be adjusted. That is, each of the plurality of buoyant columns 14 is configured to selectively adjust a buoyancy of the floating power generation platform 10, and at least one buoyant column 14 of the plurality of buoyant columns 14 may be configured to utilize active motion compensation. With reference again to FIGS. 4 and 5, each of the plurality of columns 14 includes a central, sealed column center 26 made of steel or any other suitable rigid material, and an adjustable buoyancy outer column portion 28 configured to selectively adjust a level of buoyancy of the respective column 14. The adjustable buoyancy outer column portion 28, for example, may include one or more inflatable portions, as depicted in FIGS. 4 and 5 (in an inflated state). Additionally or alternatively, the adjustable buoyancy outer column portion 28 may include a mixed buoyancy material for adjusting the buoyancy of the respective column 14. The adjustment of buoyancy of the outer column portion 28 can take place during deployment of the floating platform 10, as needed. The outer column portion 28 can be constructed of mixed buoyancy marine material(s) having properties to provide a desired lifespan under expected operating conditions. For example, the mixed buoyancy materials may include polyurethane, rubber, pliable plastics, natural airtight bladders whose volume may be increased or decreased with gas for adjusting buoyancy. Use of the adjustable buoyancy outer column portion 28 can reduce the volume, weight, and construction costs of structural steel that is used in some offshore floating platforms.

Each of the plurality of buoyant columns 14 may be cylindrical, rectangular, or specifically fitted for the support structure utilized. Alternatively, each of the plurality of buoyant columns 14 may be a different shape, such as polygonal (e.g., rectangular). The outer surface of each of the plurality of buoyant columns 14 may be tapered to provide more buoyancy lower in each column. Also, each of the plurality of buoyant columns 14 may have different shapes than each other. The primary purpose of the plurality of buoyant columns 14 is to achieve buoyancy and stability of the floating power generation platform 10 and adjust buoyancy based on the operating location.

Turning to FIG. 8, a method 100 of deploying the floating power generation platform 10 described above will be described. The method 100 includes a step 102 of assembling the floating power generation platform 10 near shore and close to a dock. During assembly, the deployable spar 22 is stowed in the hollow center core 21 of the tower 20, as described above and the plurality of buoyant columns 14 are in the unrotated position such that the floating power generation platform 10 is in the transportation configuration. The method 100 then includes a step 104 of transporting the floating power generation platform 10 to an offshore deployment location. The step 104 of transporting may include, for example, towing the floating power generation platform 10 with a boat. Once the floating power generation platform 10 is transported to the offshore deployment location, the method 100 includes the step 106 of transitioning the floating power generation platform 10 from the transportation configuration to the deployed configuration. The step 106 may include, therefore, moving the deployable spar 22 from the stowed position, in the hollow center core 21 of the tower 20, to the deployed position, extended downward from the water plane platform 16 to a predetermined operational depth to achieve overall structural stability. The step 106 may also therefore include rotating one or more of the plurality of buoyant columns 14 to the rotated position. The step 106 may also include locking the deployable spar 22 in the deployed position with the lock and connecting the plurality of buoyant columns with the cross braces 19. The method 100 may then include operating the power generation systems on the floating power generation platform 10, and if necessary under extreme weather conditions, disabling the power generation systems and/or placing the power generation systems in a survival mode for a predetermined amount of time or until the extreme weather conditions subside. For retrieval of the floating power generation platform 10, the power generation systems may be disabled and the platform 10 may be transitioned back from the deployed configuration to the transportation configuration for transportation back to shore for repair or retirement.

Although the above disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature may have been described above with respect to only one or more of several illustrated embodiments, such feature may be combined with one or more other features of the other embodiments, as may be desired and advantageous for any given or particular application.

What is claimed is:

1. A floating power generation platform comprising:
a water plane platform including a plurality of buoyant columns; and
at least one central structure extending above the water plane platform and configured to support at least one power generation system;
wherein at least one buoyant column of the plurality of buoyant columns is rotatable about a longitudinal axis of the at least one central structure, relative to at least another one buoyant column of the plurality of buoyant columns, between an unrotated position and a rotated position to move the floating power generation platform between a transportation configuration and a deployed configuration.

2. The floating power generation platform according to claim 1, wherein the plurality of buoyant columns includes a first group of two or more buoyant columns rigidly connected to each other, and a second group of two or more buoyant columns rigidly connected to each other, and wherein at least one of the first group or the second group is rotatable about the longitudinal axis of the at least one central structure between an unrotated position and a rotated position to move the floating power generation platform between a transportation configuration and a deployed configuration.

3. The floating power generation platform according to claim 1, further including one or more cross braces configured to connect two or more of the plurality of buoyant columns to each other when the plurality of buoyant columns are in the unrotated position and the floating power generation platform is in the deployed configuration.

4. The floating power generation platform according to claim 1, wherein each of the plurality of buoyant columns include a central column center and an outer column portion.

5. The floating power generation platform according to claim 4, wherein the central column center is made of a rigid material.

6. The floating power generation platform according to claim 4, wherein the outer column portion is configured to selectively adjust a buoyancy of the floating power generation platform.

7. The floating power generation platform according to claim 6, wherein the outer column portion is inflatable to selectively adjust the buoyancy of the floating power generation platform.

8. The floating power generation platform according to claim 6, wherein the outer column portion is made of a mixed buoyancy material to selectively adjust a buoyancy of the floating power generation platform.

9. The floating power generation platform according to claim 1, wherein the plurality of buoyant columns are connected to the at least one central structure with a plurality of struts.

10. The floating power generation platform according to claim 1, wherein the at least one central structure includes a tower having a hollow center core, and a deployable rigid spar.

11. The floating power generation platform according to claim 10, wherein the deployable spar is movable between a stowed position, in which the deployable rigid spar is stowed within a center core of the tower, and a deployed position, in which the deployable rigid spar is extended below the water plane platform and each of the plurality of buoyant columns.

12. The floating power generation platform according to claim 11, wherein the deployable rigid spar has a telescoping configuration for deployment and retraction.

13. The floating power generation platform according to claim 10, further comprising a lock configured to lock the deployable rigid spar in either the deployed and stowed positions.

14. A method of deploying a floating power generation platform, the method comprising the steps of:
assembling the floating power generation platform near a shore, wherein the assembling includes assembling the floating power generation platform to be configured to transition between a transportation configuration and a deployed configuration;
transporting the floating power generation platform to an offshore deployment location in the transportation configuration;
transitioning the floating power generation platform from the transportation configuration to the deployed configuration at the offshore deployment location.

15. The method according to claim 14, wherein the transitioning includes rotating one or more of a plurality of buoyant columns around a longitudinal axis of the floating power generation platform from an unrotated position to a rotated position.

16. The method according to claim 14, wherein the transitioning includes connecting the plurality of buoyant columns to each other in the rotated position.

17. The method according to claim 14, wherein the transitioning includes deploying a deployable rigid spar from a stowed position to a deployed position in which the deployable rigid spar extends beneath a water plane platform of the floating power generation platform to a predetermined operational depth.

18. The method according to claim 17, wherein the transitioning includes locking the deployable rigid spar in the deployed position.

19. The method according to claim 14, further comprising the step of operating at least one power generation system supported on the floating power generation platform.

20. The method according to claim 14, further comprising the step of disabling the at least one power generation system for a predetermined amount of time.
